(19) United States
(12) Patent Application Publication
(10) Pub. No.: US 2009/0015779 A1
(43) Pub. Date: Jan. 15, 2009

(54) LIQUID CRYSTAL DISPLAY PANEL AND METHOD OF MANUFACTURING SAME

(75) Inventor: Takeshi OHASHI, Kumamoto (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 12/166,453

(22) Filed: Jul. 2, 2008

(30) Foreign Application Priority Data
Jul. 11, 2007 (JP) 2007-182038

(51) Int. Cl. G02F 1/1339; G02F 1/1333

(52) U.S. Cl. 349/154; 445/25

(57) ABSTRACT

A liquid crystal display panel in accordance with one example of the present invention includes a TFT substrate 10, a CF substrate 20 opposed to the TFT substrate 10, a sealing material 31 to bond the TFT substrate 10 and CF substrate 20 with each other, the sealing material 31 having an opening in part of it, the sealing material 31 being formed so as to surround a display area on the inside of the edges of the TFT substrate 10 and CF substrate 20, and wall spacers 35 formed so as to extend from the sealing material 31 located near the opening of the sealing material 31 to the edges of the TFT substrate 10 and CF substrate 20.

### BACKGROUND OF THE INVENTION

1. Field of the Invention

The present invention relates to a liquid crystal display panel and a method of manufacturing the same.

2. Description of Related Art

A liquid crystal display device is composed of a liquid crystal display panel, a backlight, and so on. The liquid crystal display panel has a lower transparent insulating substrate (TFT substrate), above which thin film transistors (TFTs), an alignment layer, and so on are stacked. The liquid crystal display panel also has an upper transparent insulating substrate (color filter substrate: CF substrate), above which a color filter and an alignment layer, and so on are stacked. The TFT substrate is fabricated by forming a conductive layer that is used for various electrodes, an insulating layer, and a semiconductor layer above a transparent insulating substrate such as a glass substrate, and making them into desired patterns. The CF substrate is fabricated by forming a shielding layer, a colored layer, and a transparent conductive layer above a transparent insulating substrate such as a glass substrate, and making them into desired patterns.

The TFT substrate and CF substrate are superimposed with each other with a certain gap therebetween using in-plane spacers interposed between the substrates, and bonded together by sealing material arranged on their periphery. Then, liquid crystal is infused through a liquid crystal filling port formed in part of the sealing material, and sealed within the gap. The fabrication of the liquid crystal display panel is completed by sticking polarizing plates on the outer sides of both substrates. The backlight is placed on the outside of one of the substrates, and illuminates the liquid crystal display panel.

In a typical manufacturing process of liquid crystal display panels, a plurality of cell patterns are formed in large transparent insulating substrates (mother substrates), and then each cell pattern is cut out from the substrates. In such manufacturing process, the number of cell patterns in one pair of mother substrates can be increased by narrowing the gap between the cell patterns as much as possible. In this manner, by narrowing the gap between the cell patterns, the number of cell patterns per substrates is increased, and thereby the substrates are utilized more effectively. In addition, the productivity can be also improved.

Therefore, cell patterns should be, ideally, arranged without any gap therebetween. FIG. 11 is a plane view showing one example of mother substrates in which cell patterns 50 are arranged without any gap therebetween. In each cell pattern 50, a TFT substrate portion 10a that becomes the TFT substrate in a later process, and a CF substrate portion 20a that becomes the CF substrate in a later process are bonded together by sealing material 31. The sealing material 31 is formed in a frame shape, and has an opening in part of it. Furthermore, the sealing material 31 extends in straight lines from the opening such that they protrude beyond the edge of the cell pattern 50. The portions extending outwardly from the opening of the sealing material 31 are called “sealing material protrusion portions 32” in the present application. After the cell pattern 50 is cut out from the mother substrates, the sealing material protrusion portions 32 will act as a guide for liquid crystal when it is infused into the gap. That is, the opening portion of the sealing material 31 will act as a liquid crystal filling port 33.

Furthermore, the TFT substrate portion 10a has a larger outer dimension than that of the CF substrate portion 20a, and protrudes beyond the one side of the CF substrate portion 20a in the cell pattern 50. Terminal electrodes which will be connected externally are formed in the protrusion area 51 where the TFT substrate portion 10a protrudes beyond the CF substrate portion 20a. In FIG. 11, the protrusion area 51 is formed on the side that adjoins the side where the liquid crystal filling port 33 is formed. That is, the side where the protrusion area 51 is formed forms 90 degree angle with the side where the liquid crystal filling port 33 is formed in the rectangular cell pattern 50.

However, when one pair of mother substrates are superimposed and bonded together by thermocompression, gas that is contained in both substrates needs to be discharged from the substrates. That is, a passage of gas from the liquid crystal filling port 33 to the edge of the substrates needs to be secured in the substrates. For this reason, the sealing material protrusion portions 32 should be formed such that they are located away from the sealing material 31 of the adjacent cell pattern 50. That is, the distance from the outer edge of the cell pattern 50 to the sealing material 31 of the adjacent cell pattern 50, i.e., the distance indicated by the double-headed arrow in FIG. 11 needs to be sufficiently large. As explained above, if the arrangement shown in FIG. 11 is adopted, the substrates are eventually not utilized efficiently owing to the larger outer shapes of cell patterns 50.

Therefore, to minimize the outer shape of the cell pattern 50, the liquid crystal filling port 33 needs to be formed on the opposite side to the protrusion area 51 (opposite side to the terminals) as shown in FIG. 12. That is, the terminal electrodes are located between the sealing material protrusion portions 32 and the sealing material 31 of the adjacent cell pattern 50. In this case, the sealing material protrusion portions 32 are partially formed in the protrusion area 51 of the adjacent cell pattern 50. With such structure, the distance from the outer edge of the cell pattern 50 to the sealing material 31 of the adjacent cell pattern 50 does not need to be as large as the distance shown in FIG. 11. Therefore, the outer shape of the cell pattern 50 can become smaller, and the substrates can be utilized efficiently.

When the liquid crystal filling port 33 is formed on the opposite side to the terminals, the sealing material protrusion portions 32 are formed on the cutting line as shown in FIG. 13. Therefore, cutting becomes difficult owing to the presence of the sealing material protrusion portions 32 on the cutting line. Furthermore, as shown in FIG. 13, the protrusion area 51 of the adjacent cell pattern 50 is also adhered by the sealing material protrusion portion 32. Therefore, the insulating substrate 21 that located above the terminal electrodes 13 cannot be easily removed, and thereby the connecting to the terminal electrodes 13 externally becomes difficult. Accordingly, the cutting of the substrates and the connecting to the terminal electrodes 13 externally become difficult, and eventually it causes a decrease in the yield rate. Furthermore, there is a possibility that the sealing material protrusion portion 32 partially sits on the terminal electrode 13 of the adjacent cell pattern 50. It causes problems such as poor connection between terminals. To solve the above-mentioned problem, Japanese unexamined patent application publication 2002-98942 discloses a method in which sealing material that may sits on the protrusion area of the adjacent cell pattern is narrowed. In this manner, the amount of the sealing material that sits on the protrusion area is reduced, and thereby the above-mentioned problem is alleviated.

However, with consideration given to the fact that the displacement of the seal pattern may occurs, there is a limitation on the reduction in the width of the part of the sealing material in the technique such as Japanese unexamined patent application publication 2002-98942. That is, the sealing material needs to have a certain width. Therefore, it cannot achieve a satisfactory effect in some cases.

### SUMMARY OF THE INVENTION

In one aspect, the present invention has been made in view of the above-mentioned problems. The one of the objects of the present invention is to provide a liquid crystal display panel capable of increasing the yield rate, and a method of manufacturing the same.

In accordance to one example of the present invention, a liquid crystal display panel includes a first substrate, a second substrate opposed to the first substrate, a sealing material to bond the first substrate and the second substrates with each other, the sealing material having an opening in part of the sealing material, the sealing material being formed so as to surround a display area on the inside of the edges of the first and second substrates, and a liquid crystal filling guide formed so as to extend from the sealing material located near the opening of the sealing material to the edges of the first and second substrates.

In accordance to another example of the present invention, a liquid crystal display panel includes a first substrate, a second substrate opposed to the first substrate, and a liquid crystal filling guide to maintain the gap between the first and second substrates, the liquid crystal filling guide formed so as to extend to the edge of the first and second substrates in the first substrate.

In accordance to another example of the present invention, a method of manufacturing liquid crystal display panels includes forming a plurality of first substrate portions in a first mother substrate, forming a plurality of second substrate portions in a second mother substrate, forming a plurality of cell patterns by aligning the first and second mother substrates in opposite positions and bonding each of the plurality of first substrate portions to respective one of the plurality of second substrate portions by sealing material having an opening in part of the sealing material, each pair of the bonded first substrate portions and the respective second substrate portions having a liquid filling guide extending from the sealing material located near the opening of the sealing material, cutting the first and second mother substrates such that the cutting line straddles the liquid crystal filling guide on the outside of the sealing material, in order to divide the mother substrates along the cell patterns, and infusing liquid crystal by using the liquid crystal filling guide as a guide for the liquid crystal.

In one aspect, the present invention can provide a liquid crystal display panel capable of increasing the yield rate, and a method of manufacturing the same.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a plane view showing the structure of a liquid crystal display panel in accordance with a first embodiment of the present invention;

FIG. 2 is a cross-section as taken along the line II-II of FIG. 1;

FIG. 3 is a flowchart showing a method of manufacturing liquid crystal display panels in accordance with the first embodiment;

FIG. 4 is a plane view showing the structure of bonded mother substrates in accordance with the first embodiment;

FIG. 5 is a cross-section as taken along the line V-V of FIG. 4;

FIG. 6 is a cross-section showing the cutting state of the mother substrates in accordance with the first embodiment;

FIG. 7 is a plane view showing the structure of mother substrates in accordance with a second embodiment of the present invention;

FIG. 8 is a plane view showing the structure of mother substrates in accordance with a third embodiment of the present invention;

FIG. 9 is a cross-section showing the structure of mother substrates in accordance with a forth embodiment of the present invention;

FIG. 10 is a cross-section showing the cutting state of the mother substrates in accordance with the forth embodiment;

FIG. 11 is a plane view showing the structure of one example of mother substrates in the related art;

FIG. 12 is a plane view showing the structure of another example of mother substrates in the related art; and

FIG. 13 is a cross-section as taken along the line XIII-XIII of FIG. 12.

### DESCRIPTION OF THE PREFERRED EMBODIMENTS

### First Embodiment

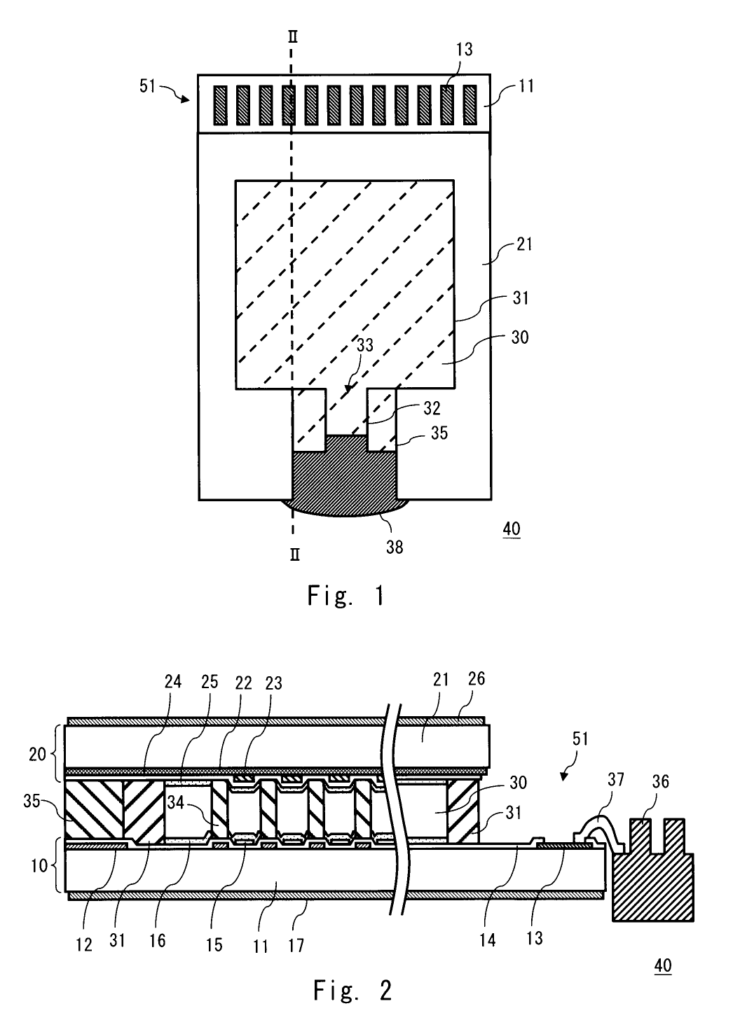

Firstly, a liquid crystal display device is explained with reference to FIGS. 1 and 2. FIG. 1 is a plane view showing the structure of a liquid crystal display panel 40. Incidentally, FIG. 1 illustrates only the essential parts of the liquid crystal display panel 40, and does not illustrate the detailed structure. FIG. 2 is a cross-section as taken along the line II-II of FIG. 1. In this embodiment, a TFT-type liquid crystal display device using thin film transistors (TFTs) as switching elements is explained as an example.

The liquid crystal display device includes a liquid crystal display panel 40, a backlight unit (not shown), and so on. As shown in FIG. 2, the liquid crystal display panel 40 has a TFT substrate 10 as a first substrate and a CF substrate 20 as a second substrate, which is located opposite to the TFT substrate 10. Furthermore, the liquid crystal display panel 40 is formed by bonding both substrates 10 and 20 together on their periphery by sealing material 31, forming a liquid crystal layer 30 between the substrates, and sealing the liquid crystal layer 30 within the gap of the substrates. The backlight unit is located on the non-viewable side of the liquid crystal display panel 40, and irradiates the liquid crystal display panel 40 from the back side of the liquid crystal display panel 40.

The TFT substrate 10 has an insulating substrate 11 on which a plurality of lines 12 are formed. A glass substrate having transparency or the like can be used for the insulating substrate 11. The plurality of lines 12 are, for example, gate lines. The gate lines are arranged in parallel with each other. Furthermore, a plurality of source lines (not shown), which intersect with the plurality of gate lines, are formed above the gate lines with an insulating film (not shown) interposed therebetween. Then, a gate signal (scanning signal) is supplied to a TFT (not shown) through the gate line. Turning on and off of the TFT is controlled in this manner. Then, a display signal (display voltage) is applied to a pixel electrode 15 (which is explained later) through the source line while the TFT is in the on-state. Furthermore, a plurality of terminal electrodes 13, each of which corresponds to the respective one of the lines 12, are formed on the substrate 11. The terminal electrodes 13 are connected to their respective lines 12, and various external signals are supplied to the lines 12 through the terminal electrodes 13. Furthermore, a transfer electrode (not shown), which transfers an input signal from the terminal electrode 13 to a common electrode 24 (which is explained later), is also formed. Then, an insulating film 14 is formed so as to cover the TFTs and the lines 12.

A pixel electrode 15 is formed above the insulating film 14 for each pixel. Specifically, the pixel electrode 15 is formed between neighboring lines 12. Furthermore, similarly to the pixel electrode 15, a TFT is also formed for each pixel. When the corresponding TFT is in the on-state, the display voltage is applied to the pixel electrode 15. Since TFTs and pixel electrodes 15 are arranged in rows, i.e., in array, the TFT substrate 10 is often called “array substrate”. Then, an alignment layer 16 is formed generally in the entire display area, which is composed of a plurality of pixels. The alignment layer 16 orientates the liquid crystal in a specific direction. Then, a polarizing plate 17 is stuck on the lower surface of the TFT substrate 10.

For the CF substrate 20, a color filter layer, a common electrode 24, and an alignment layer 25 are stacked one after another on the surface of the liquid crystal layer 30 side of the insulating substrate 21. A glass substrate having transparency or the like can be used for the insulating substrate 21. The color filter layer has a shielding layer 22 composed of black matrix (BM) or the like, and colored layers 23 of Red (R), Green (G), and Blue (B). Furthermore, the colored layers 23 and the pixel electrodes 15 are located opposed to each other. Then, the lines 12 and the shielding layer 22 are located opposed to each other. The common electrode 24 is electrically connected to a transfer electrode (not shown) located above the TFT substrate 10 through transfer material (not shown) formed between the TFT substrate 10 and CF substrate 20. An input signal that is inputted from the terminal electrode 13 is transferred to the common electrode 24 through the transfer electrode and transfer material. The common potential is supplied to the common electrode 24 in this manner. Then, an electric field is produced between the common electrode 24 and pixel electrode 15, and it drives the liquid crystal. Furthermore, a polarizing plate 26 is stuck on the opposite side of the CF substrate 20 to the liquid crystal layer 30.

Then, the TFT substrate 10 and CF substrate 20 are bonded together with sealing material 31 interposed therebetween. The sealing material 31 is formed on the inside of the edges of the substrates 10 and 20. Furthermore, the sealing material 31 is formed in a frame shape such that the sealing material 31 surrounds the display area. The sealing material 31 has an opening in part of it. Furthermore, the sealing material 31 has sealing material protrusion portions 32, which protrudes outwardly from the opening. Specifically, the sealing material protrusion portions 32 extend in two parallel straight lines from the opening. Furthermore, the sealing material protrusion portions 32 extend in the direction perpendicular to the side on which the opening of the sealing material 31 is formed. The sealing material protrusion portions 32 are formed, in the opposite side to the protrusion area 51 (opposite side to the terminals), such that the sealing material protrusion portions 32 do not extend to the edge of the liquid crystal display panel 40 in consideration of the displacement of the seal position and the accuracy of the cutting position. Furthermore, the TFT substrate 10 is formed with a larger outer dimension than that of the CF substrate 20. In this example, the TFT substrate 10 and CF substrate 20 is bonded together, by the sealing material 31, such that the TFT substrate 10 protrudes beyond the one side (one edge) of the CF substrate 20. Terminal electrodes which will be connected externally are formed in the protrusion area 51 where the TFT substrate 10 protrudes beyond the CF substrate 20.

Furthermore, a certain gap is maintained between the TFT substrate 10 and CF substrate 20 by using pillar-shaped spacers 34 as in-plane spacers. Specifically, the pillar-shaped spacers 34 are formed between the pixel electrodes 15 within the display area, and maintain the distance between the substrates in the area inside of the sealing material 31. In this manner, the distance between the substrates is determined by the pillar-shaped spacers 34 on the inside of the sealing material 31. In this embodiment, the pillar-shaped spacers 34 are provided between the shielding layer 22 and lines 12. Furthermore, wall spacers 35, which are made of the same material as the pillar-shaped spacers 34, are provided, and act as a liquid crystal filling guide. Furthermore, the pillar-shaped spacers 34 and wall spacers 35 are formed above the CF substrate 20, and are not adhered to the TFT substrate 10. As shown in FIG. 2, the wall spacers 35 are located in the opposite edge portion of the liquid crystal display panel 40 to the protrusion area 51. That is, the pillar-shaped spacers 34 are located within the display area of the liquid crystal display panel 40, and the wall spacers 35 are located in the edge portion of the liquid crystal display panel 40. Therefore, the shielding layer 22 and lines 12 are also formed in the panel edge portion where the wall spacers 35 are formed in similar manner to the pillar-shaped spacers 34 so that the gap between both substrates has the same height in both display area and panel edge portion. Incidentally, the line 12 that is formed in the panel edge portion maybe a dummy pattern formed from the same material as the line 12 that is formed in the display area.

Then, as shown in FIG. 1, the wall spacers 35 are formed such that wall spacers 35 are parallel with the sealing material protrusion portions 32 on the opposite side to the terminals. The wall spacers 35 extend from the sealing material 31 located near the opening to the edges of the substrates 10 and 20. In this embodiment, the wall spacers 35 are formed on the outside of the sealing material protrusion portions 32. That is, the sealing material protrusion portions 32 are formed in the area sandwiched by the two wall spacers 35. Typically, the sealing material protrusion portions 32 act as a guide for the liquid crystal when the liquid crystal is infused through the liquid crystal filling port 33. However, the wall spacers 35 extend on the outside of the sealing material protrusion portions 32 to the edge of the liquid crystal display panel 40 in this embodiment, so that the wall spacers 35 are used as the guide. In this manner, the liquid crystal is infused into the gap formed between the two wall spacers 35, thus the gap between the two wall spacers 35 acts as the liquid crystal filling port 33. Incidentally, the liquid crystal filling port 33 is sealed with an end-sealing material 38 after the liquid crystal is infused through the liquid crystal filling port 33. In this example, the gap between the two wall spacers 35 is sealed with the end-sealing material 38. The end-sealing material 38 is also formed in the internal space of the liquid crystal filling port 33 and the internal space of the sealing material protrusion portions 32.

Furthermore, the liquid crystal display panel 40 includes a control substrate 36, which generates various signals, and FFCs (Flexible Flat Cables) 37, which connect the control substrate 36 to the terminal electrodes 13. In this manner, these various signals are supplied from the control substrate 36 to the terminal electrodes 13 through the FFCs 37. The liquid crystal display device has the structure explained above.

Next, the operation of the liquid crystal display device is explained hereinafter. For example, when electrical signals are inputted from the control substrate 36, those various signal are supplied to the terminal electrodes 13 through the FFCs 37. Then, scanning signals or display signals are supplied to the lines 12 that are connected electrically to the terminal electrodes 13. In this manner, display voltages are supplied to the pixel electrodes 15 that are connected to the lines 12. Furthermore, a signal that is inputted to the terminal electrode 13 is transferred to the common electrode 24 through the transfer electrode and transfer material. In this manner, the common potential is supplied to the common electrode 24. Then, an electric field is produced between the pixel electrode 15 and common electrode 24.

The electric field between the pixel electrode 15 and common electrode 24 drives the liquid crystal, and the directions of molecules in the liquid crystal are changed. That is, the alignment direction of the liquid crystal between the substrates is changed. Therefore, the polarization state of light passing through the liquid crystal layer 30 will change. That is, the liquid crystal layer 30 changes the polarization state of light that has linear polarization after passing through the polarizing plate 17. Specifically, light from the backlight unit that is used as the light source, and external light that enters from the outside of the display device becomes linear-polarization light by the polarizing plate 17. Then, as the light having linear-polarization passes through the liquid crystal layer 30, the polarization state is changed.

Therefore, the amount of the light that passes through the polarizing plate 26 on the CF substrate 20 side varies depending on the polarization state. That is, an amount of light transmitted through the polarizing plate 26 on the viewable side out of the light emitted from the backlight unit and transmitted through the liquid crystal panel 40 is changed. The alignment direction of the liquid crystal changes depending on the applied display voltage. Therefore, the amount of the light that passes through the polarizing plate 26 on the viewable side can be varied by controlling the display voltage. That is, a desired image can be displayed by changing the display voltages on a pixel-by-pixel basis.

Incidentally, the structure of the above-described liquid crystal display panel 40 is just one example, and other structures can be used as substitutes. Furthermore, the operating mode of the liquid crystal display panel 40 may be TN (Twisted Nematic) mode, STN (Super Twisted Nematic) mode, ferroelectricity liquid crystal mode, or the like. Incidentally, when IPS (In-Plane Swithing) mode, for example, is to be used, the common electrode 24, which is provided on the CF substrate 20 in FIG. 2, should be located on the TFT substrate 10 side. In this manner, an electric field is produced in the transverse direction to the liquid crystal between the pixel electrode 15 and common electrode 24. As explained above, a liquid crystal display panel using transverse electric field mode can be also used for the liquid crystal display panel 40. Furthermore, the driving method may be a passive matrix, an active matrix, or the like. As explained above, the present invention is applicable to a variety of liquid crystal display panels 40.

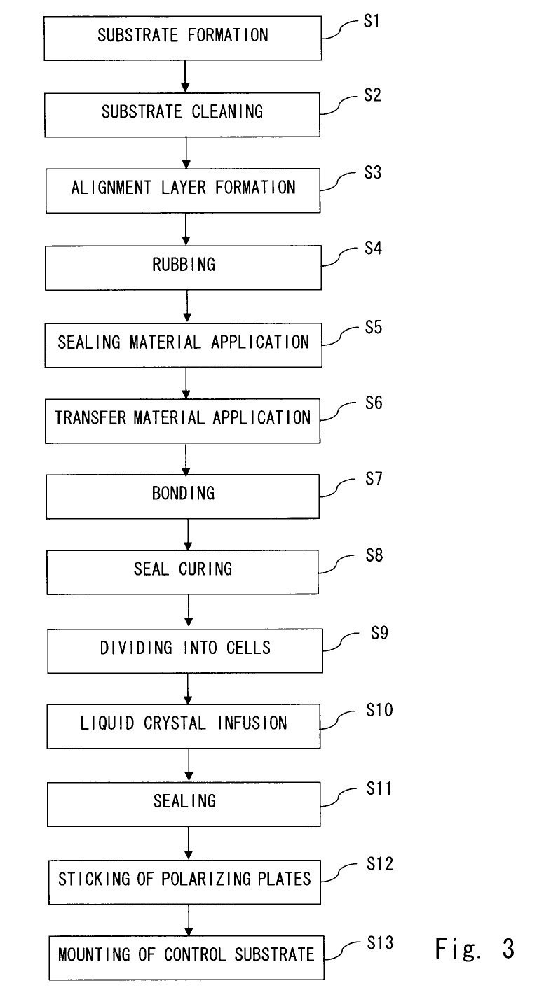

Next, a method of manufacturing liquid crystal display panels 40 is explained hereinafter with reference to FIG. 3. FIG. 3 is a flowchart showing a method of manufacturing liquid crystal display panels 40.

Firstly, a first mother substrate having a plurality of TFT substrate portions, and a second mother substrate having a plurality of CF substrate portions are prepared (step Si). Incidentally, the first and second mother substrates correspond to the insulating substrates 11 and 12 respectively shown in FIG. 2. Furthermore, the TFT substrate portions and CF substrate portions will become the TFT substrates 10 and CF substrates 20 in a later process. Since a conventional method can be used for this process, the process is briefly explained hereinafter.

Several pattern formation processes, each including film formation, patterning by photolithography, etching, and the like, are carried out repeatedly on one side of the first mother substrate such as a glass substrate. In this manner, patterns of switching elements such as TFTs, lines 12, terminal electrodes 13, insulating films 14, and pixel electrodes 15 are formed on the one side of the first mother substrate. Then, a plurality of TFT substrate portions are formed on the first mother substrate. Furthermore, patterns of a shielding layer 22, a colored layer 23, and a common electrode 24 are formed on one side of the second mother substrate such as a glass substrate in a similar manner to that of the first mother substrate. In this manner, a plurality of CF substrate portions are formed on the second mother substrate. Furthermore, the rectangular TFT substrate portions and rectangular CF substrate portions are arranged such that the long side and short side of each of them are parallel to the long side and short side respectively of the rectangular first and second mother substrates. Then, the TFT substrate portions and CF substrate portions are arranged in an orderly fashion. In this manner, a plurality of cell patterns are efficiently arranged in a pair of the mother substrates.

Furthermore, pillar-shaped spacers 34 and wall spacers 35, which act as a liquid crystal filling guide, are formed on each CF substrate portions in this embodiment. Patterns of the pillar-shaped spacers 34 and wall spacers 35 are simultaneously formed by photolithography. Specifically, light curing resin or the like, which becomes material for the spacers, is applied over the substrate. Next, exposure is carried out through a photomask to expose the light curing resin to light. Then, the patterns of the pillar-shaped spacers 34 and wall spacers 35 are formed by developing the light curing resin. The wall spacers 35 are formed on the outside of the area where the sealing material protrusion portions 32 are formed in a later process, extending from the one side of the sealing material 31 on which an opening is formed in a later process, to the protrusion area 51 of the adjacent TFT substrate portion. Incidentally, the wall spacers 35 need to be formed so as to extend to the adjacent TFT substrate portion, i.e., the protrusion area 51 of the adjacent cell pattern, in consideration of the displacement of the seal position and the accuracy of the cutting position. In this manner, the wall spacers 35 are formed so as to extend beyond the border with the adjacent cell pattern.

Next, the first mother substrate is cleaned in a substrate cleaning process (step S2). Then, an alignment layer 16 is formed on the same surface of the first mother substrate as the pixel electrodes 15 are formed, in an alignment layer formation process (step S3). In this process, for example, an organic film is applied over the substrate by printing to form the alignment layer 16. Then, the film is calcinated and dried by a hot plate or the like. Then, the alignment layer 16 is rubbed to orientate the alignment layer 16 in rubbing process (step S4).

Furthermore, the substrate cleaning, alignment layer formation, and rubbing are also carried out on the second mother substrate in a similar manner to the steps S2 to S4. Incidentally, the alignment layer 25 is formed on the same surface of the second mother substrate as the common electrode 24 is formed.

Next, the application process of the sealing material 31 is carried out on the surface of either first or second mother substrate, where the electrodes were formed in the earlier process, by a screen printing device in a sealing material application process (step S5). For example, thermosetting resin such as an epoxide-based adhesive, or ultraviolet curable resin can be used for the sealing material 31. In this manner, a seal pattern having an opening in part of it is formed in a frame shape, and sealing material protrusion portions 32 are formed such that they extend outwardly from the opening. The sealing material protrusion portion 32 is not formed on the edges of both TFT substrate potion and CF substrate portion.

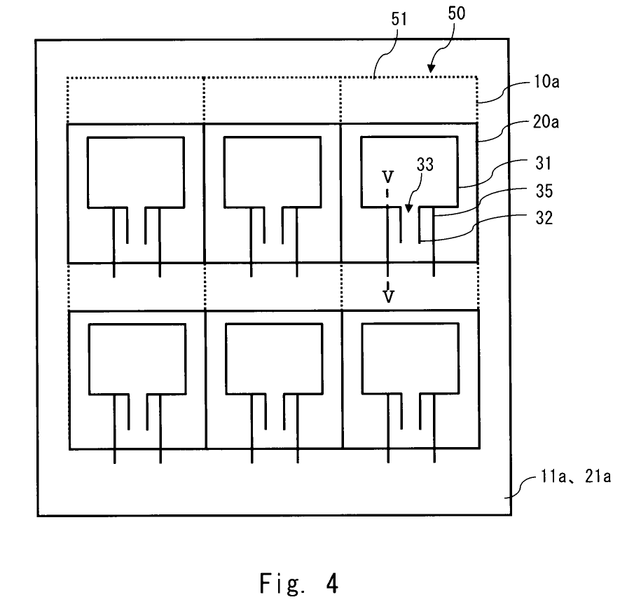

Next, the application process of transfer material is carried out on the surface of either first or second mother substrate, where the electrodes were formed in the earlier process, in a transfer material application process (step S6). Then, the first and second mother substrates are bonded together in a bonding process (step S7). In this manner, as shown in FIG. 4, the TFT substrate portions 10a and the corresponding CF substrate portions 20a are bonded together. Then, a plurality of cell patterns 50 are formed in array. FIG. 4 is a plane view showing the structure of bonded mother substrates. Then, the sealing material 31 is completely cured with the first mother substrate 11a and second mother substrate 21a being bonded together in a seal curing process (step S8). This process is carried out by, for example, heating the sealing material 31 or irradiating ultraviolet light to the sealing material 31 in accordance with the material properties of the sealing material 31.

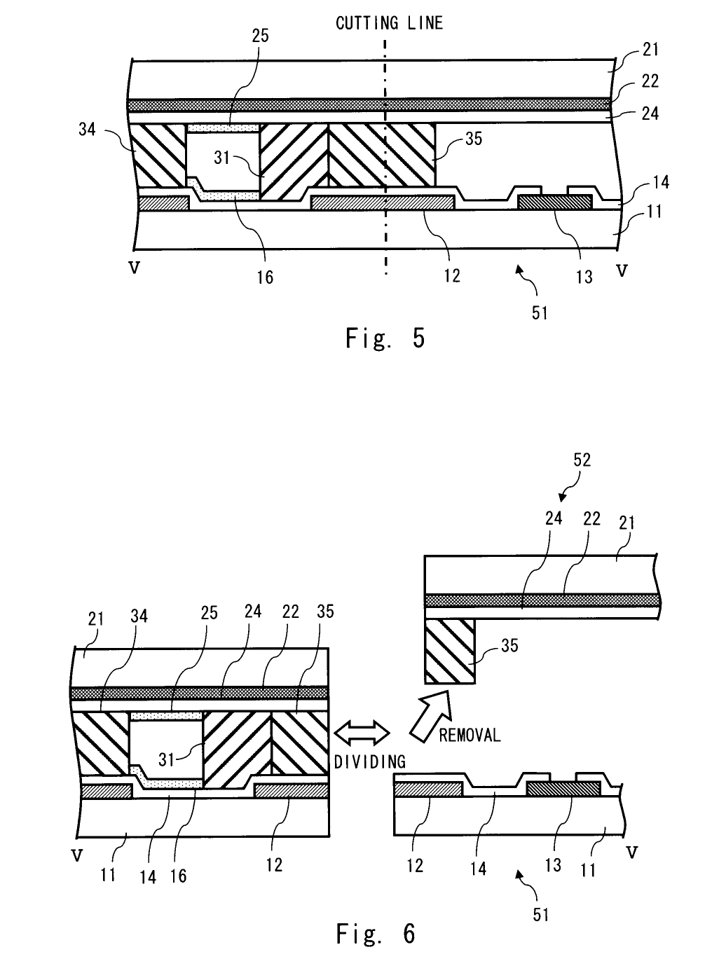

Next, the bonded mother substrates are divided along cell patterns 50 in a cell dividing process (step S9). Specifically, the mother substrates 11a and 21a are cut such that the cutting line straddles the wall spacers 35 on the outside of the sealing material 31, in order to divide the mother substrates 11a and 21a along the cell patterns 50. That is, the lines 12, shielding layer 22, and wall spacers 35 are cut in the vicinity of the protrusion area 51 of the adjacent cell pattern 50. In this example, the cutting is carried out along the dashed line shown in FIG. 5. FIG. 5 is a cross-section as taken along the line V-V of FIG. 4. As shown in FIG. 5, since the sealing material protrusion portion 32 is not formed on the cutting line, the sealing material protrusion portion 32 is not severed. Therefore, the cutting is easier, and the yield rate in the cutting will be improved.

Then, as shown in FIG. 6, an unwanted part 52 having the insulating substrate 21 or the like, which is opposed to the protrusion area 51, is removed in order to expose the terminal electrodes 13 of the protrusion area 51. FIG. 6 is a cross-section showing the cutting state of the mother substrates. That is, FIG. 6 shows the state after the mother substrates are cut along the dashed line shown in FIG. 5. As seen from FIGS. 4-6, the wall spacers 35 are formed so as to extend to the inside of the protrusion area 51 of the adjacent cell pattern 50. Furthermore, the wall spacers 35 contact with the protrusion area 51 of the adjacent cell pattern 50. Specifically, the wall spacers 35 contact with the insulating film 14 in the protrusion area 51 of the adjacent cell pattern 50. The wall spacers 35 are formed on the CF substrate portion 20a, and cured before the CF substrate portion 20a is stuck to the TFT substrate portion 10a. Therefore, the adhesion force between the wall spacers 35 and the surface of the TFT substrate portion 10a in the protrusion area 51 is not strong. Thus, the unwanted part 52 is easily removed from the protrusion area 51. In this manner, the terminal electrodes 13 are exposed, and connected externally.

As explained above, since the wall spacers 35, rather than the sealing material protrusion portions 32, contacts to the protrusion area 51 in this embodiment, the terminal electrodes 13 can be easily exposed and connected externally. That is, the liquid crystal display panel 40 and unwanted part 52 are easily disengaged from each other. Furthermore, in this example, since the wall spacers 35 are formed on the CF substrate portion 20a, the unwanted part 52 is adhered to the wall spacers 35. Therefore, the wall spacers 35 can be removed by taking it away with the unwanted part 52. In this manner, the wall spacers 35 can be removed. Therefore, even if the wall spacer 35 partially sits on the terminal electrodes 13 when the mother substrates are bonded together, it can be easily removed in a later process. Specifically, since the wall spacers 35 are formed on the CF substrate portion 20a, the wall spacers 35 can be easily removed to expose the terminal electrodes 13 and the terminal electrodes 13 can be easily connected externally. Therefore, problems such as poor connection between terminals will be substantially alleviated.

Then, liquid crystal is infused through the liquid crystal filling port 33 for each cell pattern 50 in a liquid crystal infusion process (step S10). This process is carried out by filling up the internal space with liquid crystal through the liquid crystal filling port 33 by vacuum infusion. In the vacuum infusion, for example, a liquid crystal boat containing liquid crystal and the cell pattern 50 are arranged in a vacuum chamber. Then, the gap of the cell pattern 50 and the liquid crystal are degassed by discharging air and reducing the pressure within the vacuum chamber. After that, the liquid crystal filling port 33 located on the lower edge of the cell pattern 50 is brought into contact with the liquid crystal in the liquid crystal boat. Then, by increasing the pressure within the vacuum chamber to the atmospheric pressure, the liquid crystal in the liquid crystal boat is sucked into the cell pattern 50 by the capillary action and the pressure difference between the inside and outside of the cell pattern 50. In this embodiment, the wall spacers 35 arranged at the both sides of the sealing material protrusion portions 32, rather than the sealing material protrusion portions 32 themselves, act as an effective guide for liquid crystal. That is, liquid crystal is infused into the gap by using the wall spacers 35 as a guide. Then, as shown in FIG. 1, the internal spaces within the wall spacers 35 and within the sealing material 31 are filled up with the liquid crystal.

Next, the liquid crystal filling port 33 is sealed with an end-sealing material 38, in particular by pressure sealing, in a sealing process (step S11). In this process, curing-type resin is applied to the liquid crystal filling port 33 as the end-sealing material 38 while pressure is applied to the cell pattern 50 in the thickness direction of the cell pattern 50. After that, by ceasing the pressurization to the cell pattern 50, the curing-type resin is pulled into the liquid crystal filling port 33. Then, the curing-type resin is irradiated with light to form the end-sealing material 38. In this process, a coating of the end-sealing material 38 is applied to the liquid crystal filling port 33 so that the liquid crystal filling port 33 is sealed together with the wall spacers 35. Incidentally, in this embodiment, the filling of liquid crystal and the sealing can be carried out even though the sealing material protrusion portions 32 do not extend to the edge of the cell pattern 50, because of the formation of the wall spacers 35. Next, polarizing plates 17 and 26 are stuck to the liquid crystal cell in a polarizing plate sticking process (step S12). Finally, a control substrate 36 is mounted to the liquid crystal cell in a control substrate mounting process (step S13). In this manner, the manufacture of the liquid crystal display panel 40 is completed.

As explained above, the cutting of the cell pattern 50 and the connecting to the terminal electrodes 13 externally can be easily carried out, owing to the formation of the wall spacers 35. As a result, the yield rate will be improved. In addition, since the liquid crystal filling port 33 can be formed on the opposite side to the terminals, the outer dimensions of the panel can be reduced. Furthermore, since the wall spacers 35 can be formed in the same process as the pillar-shaped spacers 34, the manufacturing cost can be also reduced.

### Second Embodiment

This embodiment is different from the first embodiment in that the wall spacers 35 are formed on the inside of the sealing material protrusion portions 32. Incidentally, other structures and manufacturing processes are the same as those of the first embodiment, and therefore explanation of them is omitted.

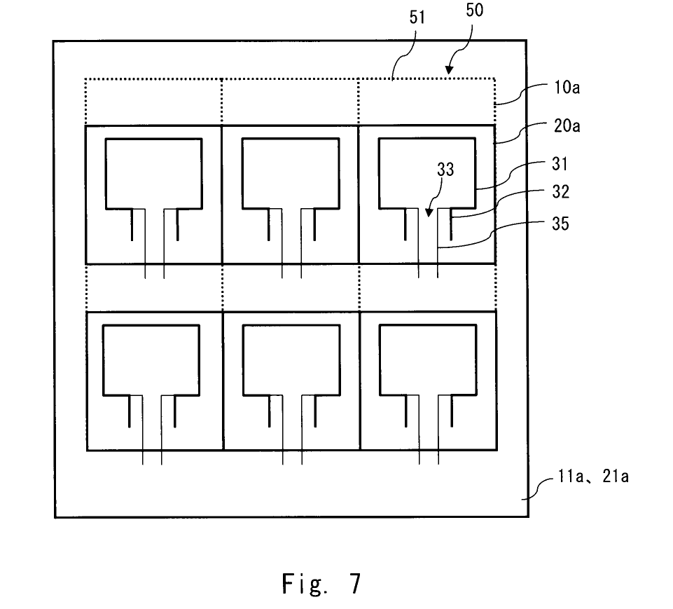

A liquid crystal display panel in accordance with this embodiment is explained hereinafter with reference to FIG. 7. FIG. 7 is a plane view showing the structure of the bonded mother substrates. That is, FIG. 7 shows the mother substrates in the step S7 shown in FIG. 3. As shown in FIG. 7, the sealing material 31 formed in a frame shape has an opening in part of it. Then, sealing material protrusion portions 32 are formed outwardly from this opening. Specifically, two sealing material protrusion portions 32 are formed such that they extend in parallel with each other from one side of the sealing material 31 on which the opening is formed in the direction perpendicular to that side. Then, wall spacers 35 are formed on the inside of the sealing material protrusion portions 32 such that the wall spacers 35 extend in parallel with each other in two straight lines to the inside of the protrusion area 51 of the adjacent cell pattern 50. That is, the wall spacers 35 are formed in the area inside of the two sealing material protrusion portions 32. Incidentally, the sealing material protrusion portions 32 and wall spacers 35 are formed in parallel with each other. Furthermore, the wall spacers 35 bend, on the side near the opening of the sealing material 31, at 90° toward the edge of the seal pattern formed in a frame shape. That is, each wall spacer 35 is formed in an L-shape. As explained above, the wall spacers 35 are formed so as to connect to the edge of the seal pattern.

Although the wall spacers 35 are formed on the inside of the sealing material protrusion portions 32 in this manner, similar advantageous effects to those of the first embodiment are obtained. Furthermore, liquid crystal is contained only in the gap surrounded by the wall spacers 35, which are formed on the inside of the sealing material protrusion portions 32, in the vicinity of the liquid crystal filling port 33. Therefore, the amount of infused liquid crystal can be reduced.

### Third Embodiment

This embodiment is different from the first embodiment in that the wall spacers 35 are formed such that the wall spacers 35 adjoin the sealing material protrusion portions 32. Incidentally, other structures and manufacturing processes are the same as those of the first embodiment, and therefore explanation of them is omitted.

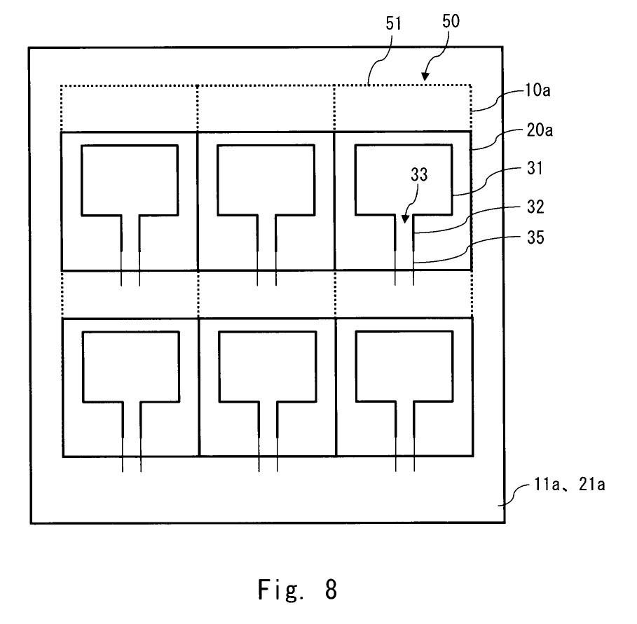

A liquid crystal display panel in accordance with this embodiment is explained hereinafter with reference to FIG. 8. FIG. 8 is a plane view showing the structure of the bonded mother substrates. That is, FIG. 8 shows the mother substrates in the step S7 shown in FIG. 3. As shown in FIG. 8, the sealing material 31 formed in a frame shape has an opening in part of it. Then, two sealing material protrusion portions 32 are formed outwardly in parallel from this opening. Two wall spacers 35 are formed such that they extend in parallel from the edges of the sealing material protrusion portions 32 to the protrusion area 51 of the adjacent cell pattern 50. Furthermore, each sealing material protrusion portion 32 and the corresponding wall spacer 35 are formed in a straight line. Incidentally, the sealing material protrusion portions 32 and wall spacers 35 overlap one another at the end portions where the sealing material protrusion portions 32 and wall spacers 35 contact with each other.

Although the wall spacers 35 are formed so as to adjoin the sealing material protrusion portions 32 in this manner, similar advantageous effects to those of the first and second embodiments are obtained.

### Fourth Embodiment

This embodiment is different from the first embodiment in that the pillar-shaped spacers 34 and wall spacers 35 are formed on the TFT substrate 10 side between the lines 12 and colored layer 23. Incidentally, other structures and manufacturing processes are the same as those of the first embodiment, and therefore explanation of them is omitted.

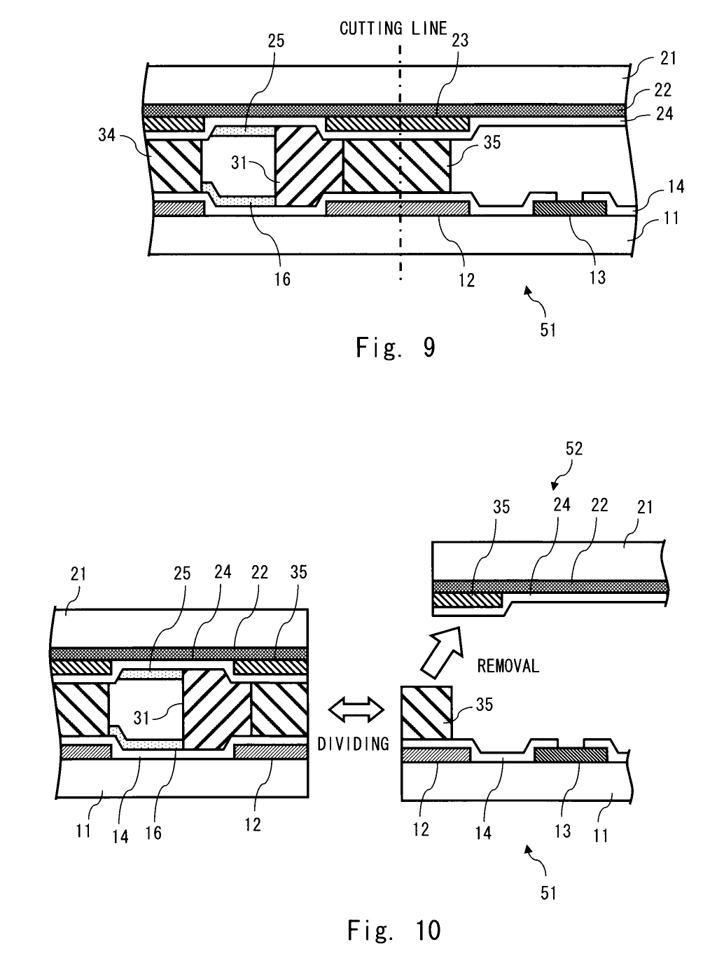

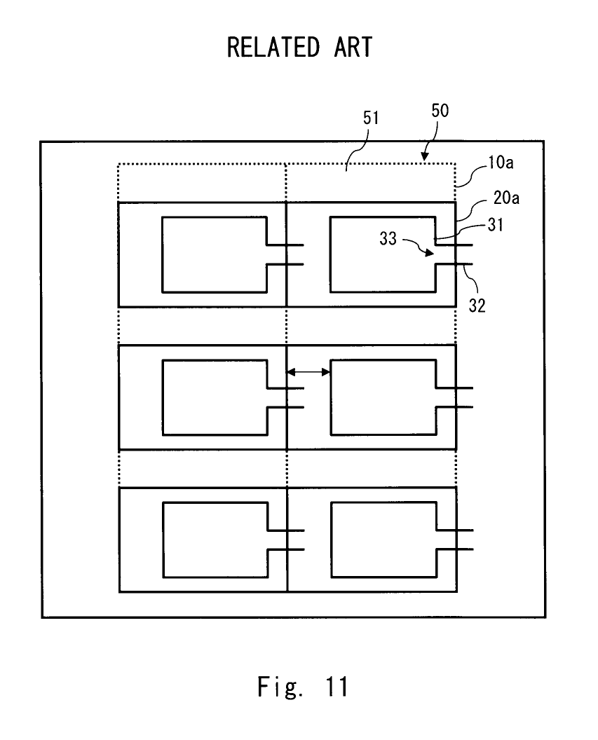

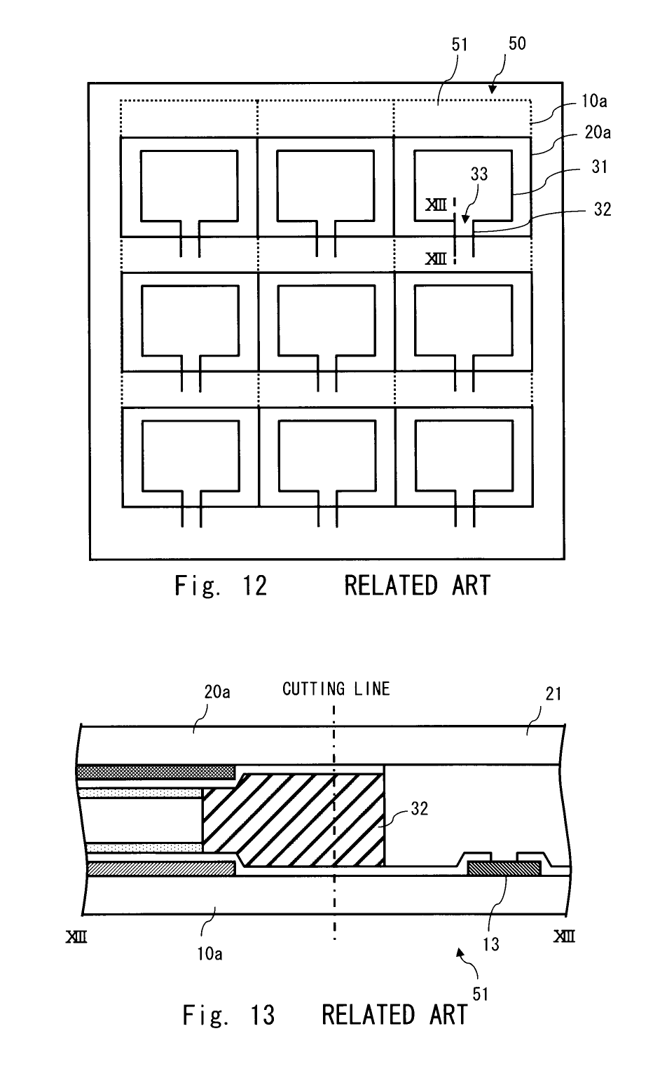

A liquid crystal display panel in accordance with this embodiment is explained hereinafter with reference to FIG. 9. FIG. 9 is a cross-section showing the structure of the bonded mother substrates. That is, FIG. 9 shows the mother substrates in the step S7 shown in FIG. 3. In this embodiment, the pillar-shaped spacers 34 and wall spacers 35 are formed between the lines 12 and colored layer 23. That is, the lines 12 and colored layer 23 are located opposite to each other. Therefore, the gap between both substrates has the same height in both display area and panel edge portion. Incidentally, similarly to the first embodiment, the line 12 that is formed in the panel edge portion may be a dummy pattern formed from the same material as the line 12 that is formed in the display area.

Then, the substrates are cut along the dashed line shown in FIG. 9. That is, the lines 12, colored layer 23, and wall spacers 35 are severed. As shown in FIG. 9, since the sealing material protrusion portion 32 is not formed on the cutting line, the sealing material protrusion portion 32 is not severed. Therefore, the cutting is easier, and the yield rate in the cutting will be improved. Then, as shown in FIG. 10, an unwanted part 52 having the insulating substrate 21 or the like, which is opposed to the protrusion area 51, is removed in order to expose the terminal electrodes 13 in the protrusion area 51. FIG. 10 is a cross-section showing the cutting state of the mother substrates. That is, FIG. 10 shows the state after the mother substrates are cut along the dashed line shown in FIG. 9. In this manner, connecting to the terminal electrodes 13 externally can be carried out by removing the unwanted part 52.

Similarly to other embodiments, the wall spacers 35, rather than the sealing material protrusion portions 32, contact to the unwanted part 52 in this embodiment. Specifically, the wall spacers 35 contact with the common electrode 24 that is opposed to the protrusion area 51 of the adjacent cell pattern 50. Therefore, the adhesion force between the wall spacers 35 and the surface of the unwanted part 52 is not strong. Thus, exposing the terminal electrodes 13 and connecting to the terminal electrodes 13 externally can be easily carried out. That is, the liquid crystal display panel 40 and unwanted part 52 are easily disengaged from each other. In this manner, similar advantageous effects to those of the first embodiment are obtained in this embodiment.

Furthermore, if desired, above-described embodiments can be combined with each other. For example, when the second embodiment is combined with the fourth embodiment, the wall spacers 35 are formed on the inside of the sealing material protrusion portions 32. Then, the pillar-shaped spacers 34 and wall spacers 35 are formed on the TFT substrate 10 side. Needless to say, other combinations such as combination of the first embodiment and the second or third embodiment are also possible.

In the structure of the first embodiment where the wall spacers 35 are formed on the CF substrate 20 side, the lines 33 12 and shielding layer 22 are located opposed to each other. Furthermore, in the structure of this embodiment where the wall spacers 35 are formed on the TFT substrate 10 side, the lines 12 and colored layer 23 are located opposed to each other. The present invention is not limited to these structures. For example, structure in which the lines 12 and colored layer 23 are located opposed to each other may be adopted in the first embodiment. Furthermore, for example, structure in which the lines 12 and shielding layer 22 are located opposed to each other may be adopted in this embodiment. Furthermore, other structures may be also used in the present invention, provided that the gap between both substrates has the same height in both display area and panel edge portion. The above-described advantageous effects will be still obtained in such embodiments. Furthermore, the formation of sealing material protrusion portions 32 is not necessarily required in the first and second embodiments. However, the sealing material protrusion portions 32 are preferably formed in these embodiments so that the strength (adhesion force between both substrates) is improved.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A liquid crystal display panel comprising:
a first substrate;
a second substrate opposed to the first substrate;
a sealing material to bond the first substrate and the second substrates with each other, the sealing material having an opening in part of the sealing material, the sealing material being formed so as to surround a display area on the inside of the edges of the first and second substrates; and
a liquid crystal filling guide formed so as to extend from the sealing material located near the opening of the sealing material to the edges of the first and second substrates.

2. The liquid crystal display panel according to claim 1, further comprising:
a protrusion area at one edge of the first substrate, the protrusion area extending beyond the edge of the second substrate; and
terminal electrodes formed on the protrusion area;
wherein the liquid crystal filling guide is formed on the opposite side to the protrusion area.

3. The liquid crystal display panel according to claim 1, wherein the liquid crystal filling guide is formed above either the first substrate or the second substrate.

4. The liquid crystal display panel according to claim 2, wherein the liquid crystal filling guide is formed above either the first substrate or the second substrate.

5. The liquid crystal display panel according to claim 1, further comprising pillar-shaped spacers to maintain the gap between the first and second substrates in the display area,
wherein the liquid crystal filling guide is made of the same material as the pillar-shaped spacers.

6. The liquid crystal display panel according to claim 2, further comprising pillar-shaped spacers to maintain the gap between the first and second substrates in the display area,
wherein the liquid crystal filling guide is made of the same material as the pillar-shaped spacers.

7. The liquid crystal display panel according to claim 3, further comprising pillar-shaped spacers to maintain the gap between the first and second substrates in the display area,
wherein the liquid crystal filling guide is made of the same material as the pillar-shaped spacers.

8. The liquid crystal display panel according to Claim 4, further comprising pillar-shaped spacers to maintain the gap between the first and second substrates in the display area,
wherein the liquid crystal filling guide is made of the same material as the pillar-shaped spacers.

9. A liquid crystal display panel comprising:
a first substrate,
a second substrate opposed to the first substrate, and
a liquid crystal filling guide to maintain the gap between the first and second substrates, the liquid crystal filling guide formed so as to extend to the edge of the first and second substrates in the first substrate.

10. A method of manufacturing liquid crystal display panels comprising:
forming a plurality of first substrate portions in a first mother substrate,
forming a plurality of second substrate portions in a second mother substrate,
forming a plurality of cell patterns by aligning the first and second mother substrates in opposite positions and bonding each of the plurality of first substrate portions to respective one of the plurality of second substrate portions by sealing material having an opening in part of the sealing material, each pair of the bonded first substrate portions and the respective second substrate portions having a liquid filling guide extending from the sealing material located near the opening of the sealing material,
cutting the first and second mother substrates such that the cutting line straddles the liquid crystal filling guide on the outside of the sealing material, in order to divide the mother substrates along the cell patterns, and
infusing liquid crystal by using the liquid crystal filling guide as a guide for the liquid crystal.

11. The method of manufacturing liquid crystal display panels according to claim 10, wherein each liquid crystal display panel has terminal electrodes in a protrusion area formed at one edge of the first substrate, the protrusion area protruding beyond the edge of the second substrate, and
wherein the liquid crystal filling guide is formed such that the liquid crystal filling guide extends to the protrusion area of the adjacent cell pattern, in the cell pattern formation step; and
the method further comprises, after the cell pattern cutting process, cutting and removing unwanted parts from the second mother substrates, each unwanted part being located opposed to the corresponding protrusion area.

12. The method of manufacturing liquid crystal display panels according to claim 10, wherein the liquid crystal filling guide is formed above either the first mother substrate or the second mother substrate in the cell pattern formation step.

13. The method of manufacturing liquid crystal display panels according to claim 11, wherein the liquid crystal filling guide is formed above either the first mother substrate or the second mother substrate in the cell pattern formation step.

14. The method of manufacturing liquid crystal display panels according to claim 10, wherein pillar-shaped spacers are formed simultaneously with the liquid crystal filling guide in the cell pattern formation step, the pillar-shaped spacers maintaining the gap between the first and second mother substrates in the display area.

15. The method of manufacturing liquid crystal display panels according to claim 11, wherein pillar-shaped spacers are formed simultaneously with the liquid crystal filling guide in the cell pattern formation step, the pillar-shaped spacers maintaining the gap between the first and second mother substrates in the display area.

16. The method of manufacturing liquid crystal display panels according to claim 12, wherein pillar-shaped spacers are formed simultaneously with the liquid crystal filling guide in the cell pattern formation step, the pillar-shaped spacers maintaining the gap between the first and second mother substrates in the display area.

17. The method of manufacturing liquid crystal display panels according to claim 13, wherein pillar-shaped spacers are formed simultaneously with the liquid crystal filling guide in the cell pattern formation step, the pillar-shaped spacers maintaining the gap between the first and second mother substrates in the display area.
